(19) United States
(12) Patent Application Publication
(10) Pub. No.: US 2012/0280101 A1
(43) Pub. Date: Nov. 8, 2012

(54) MEDIA HANGER/GUIDE

(75) Inventors: William M. Bouverie, Windermere, FL (US); Mark Allen Hitz, Rock Hill, SC (US); Dwayne Steven Tobin, Longwood, FL (US)

(73) Assignee: SOURCE TECHNOLOGIES, LLC, Charlotte, NC (US)

(21) Appl. No.: 13/463,074

(22) Filed: May 3, 2012

Related U.S. Application Data
(60) Provisional application No. 61/482,489, filed on May 4, 2011.

(51) Int. Cl. F16M 13/00; F16B 2/20; F16B 2/12

(52) U.S. Cl. 248/316.4

(57) ABSTRACT

A media hanger/guide including a base plate having a first surface and a second surface opposed to the first surface, a guide extending into the second surface, a first support member and a second support member adapted for sliding movement along the guide relative to the base plate second surface, and a clamp secured to the base plate second surface and engaged with the support members and such that the clamp is movable between a first position adapted for permitting insertion of a media between the first support member and the second support member and a second position adapted for providing force on the first support member and the second support member. A slot may also extend into the second surface. An optional lock may be movably secured to the base plate for locking the first and second support members and in a predetermined position along the base plate.

### CROSS-REFERENCE To RELATED APPLICATION(S)

This application claims priority to provisional patent application No. 61/482,489, filed May 4, 2011, and entitled “Media Hanger/Guide”, the contents of which are incorporated in full by reference herein.

### FIELD OF DISCLOSURE

The present invention generally relates to media hangers utilized in printers and the like, more specifically, a media hanger/guide that utilizes compressive forces to hold media therein.

### BACKGROUND

Printing systems such as copiers, printers, facsimile devices or other systems having a print engine for creating visual images, graphics, texts, etc. on a page or other printable medium typically include various media feeding systems for introducing original image media or printable media into the system. Examples include direct thermal and thermal transfer demand printers. Typically, a thermal transfer printer is a printer which prints on media by melting a coating of ribbon so that it stays glued to the media on which the print is applied. It contrasts with direct thermal printing where no ribbon is present in the process. Typically, thermal transfer printers comprise at least one supply spindle operable for supplying a media web and ribbon, a print station, and a take up spindle. New ribbon and media is fed from the supply spindle along a predetermined media feed path to the print station for printing and then the ribbon is wound up by the take up spindle while the media is exited from the print station.

Problems with current printing systems, however, include within the media feed path alignment and compression issues which may result in faulty or defective printing. Media hangers and/or guides, also referred to as media storage assemblies, are utilized in such printers and associated devices so as to retain a supply of media and ribbon and initially guide the media through the predetermined media feed path of the printer. Heretofore, the type of media hanger utilized in printers has been dependent upon the type and size of media utilized. This dependency severely limits the anticipated use of the media hanger, and the printer, to only one media type and size. Undesirably, the lack of versatility and configurability in accommodating varying media types and sizes causes a need for separate printers and media guides to be purchased if printing on various media is desired.

Additionally, conventional media hangers require the manual movement or manipulation of one support member at a time in order to position a media supply media on or about an assembly. However, such movement may result in the media being off center relative to the media feed path. Thus, there exists a need in the art for a media hanger that is operable for being configured to accommodate varying media types and sizes while maintaining the media in a centered position relative to a media feed path. It would be desirable to provide a media hanger which, therefore, moves in a synchronized manner in response to movement of the support members in either an expansive and compressive a manner.

Further, conventional media hangers utilize various means of retention for a media supply. Known methods attempt to retain the media via compressive forces. However, existing compressions methods do not adequately provide for a proper amount of pressure being exerted on the media. Indeed, known methods and means may resolve to the media slipping from the media hanger. Thus, there exists a need to utilize a media hanger that applies an amount of pressure on the media so as to avoid slippage.

Finally, it is desirable to have an alert triggered when the media supply reaches a predetermined level. Conventional media hangers lack such a integral feature. Thus, a media sensor providing such information is desired. While some existing methods provide an additional sensor, heretofore, current systems do not provide for an integral low media sensor.

### SUMMARY OF THE DISCLOSURE

The present invention is designed to overcome the deficiencies and shortcomings of devices conventionally known and described above. The present invention is designed to reduce the manufacturing costs and the complexity of assembly. In all exemplary embodiments, the present invention provides a media hanger operable for use within a printing system that may be utilized in conjunction with a variety of media types and sizes and which overcomes the noted shortcomings of existing systems by combining with a print station system various options containing features which expand the overall functionality of a printer.

The present disclosure overcomes the noted shortcomings associated with conventional devices and provides a configurable and adaptable media hanger that may be utilized in conjunction with a variety of media types and sizes. Moreover, in exemplary embodiments, the present invention utilizes support members which are synchronized in movement so as to center the media within the hanger. In exemplary embodiments, the present invention also utilizes compressive forces on the support members to retain the media within the hanger. Finally, the present invention provides an integral low media sensor configured to detect low media such that an alert to a user may be triggered or displayed.

In one example embodiment, the present disclosure relates to a media hanger including a base plate operable for mounting to a surface within a printing system and having a first surface and a second surface opposed to the first surface. Extending through the base plate is at least one guide track or guide operable for receiving and maintaining first and second media support members and for permitting sliding movement of the support members along a defined path within the base plate. A clamp may be provided and configured to be secured to the base plate such that when engaged with either the first or second support members the clamp is movable between a first position adapted for permitting insertion of a media (not shown) between the first support member and the second support member and a second position adapted for providing force on the first support member and the second support member. In exemplary embodiments, an optional lock may be provided and movably secured to the base plate for locking the first and second support members in a predetermined position along the base plate.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof.

### BRIEF DESCRIPTION OF THE DRAWINGS

The present subject matter may take form in various components and arrangements of components, and in various steps and arrangements of steps. The appended drawings are only for purposes of illustrating exemplary embodiments and are not to be construed as limiting the subject matter.

FIG. 1 is a perspective front view of a media hanger operable for use with a thermal direct transfer printer in an compressed or closed position in according to one example embodiment of the present disclosure;

FIG. 2 is a front view of the embodiment of FIG. 1;

FIG. 3 is a bottom view of the embodiment of FIG. 1;

FIG. 4 is a perspective front view of a media hanger operable for use with a thermal direct transfer printer in an expanded or open position in according to one example embodiment of the present disclosure;

FIG. 5 is a front view of the embodiment of FIG. 4; and

FIG. 6 is a bottom view of the embodiment of FIG. 4.

### DETAILED DESCRIPTION

The present invention will now be described more fully hereinafter with reference to the accompanying drawings in which exemplary embodiments of the invention are shown. However, this invention may be embodied in many different forms and should not be construed as limited to the embodiments set forth herein. These exemplary embodiments are provided so that this disclosure will be both thorough and complete, and will fully convey the scope of the invention to those skilled in the art. Further, as used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

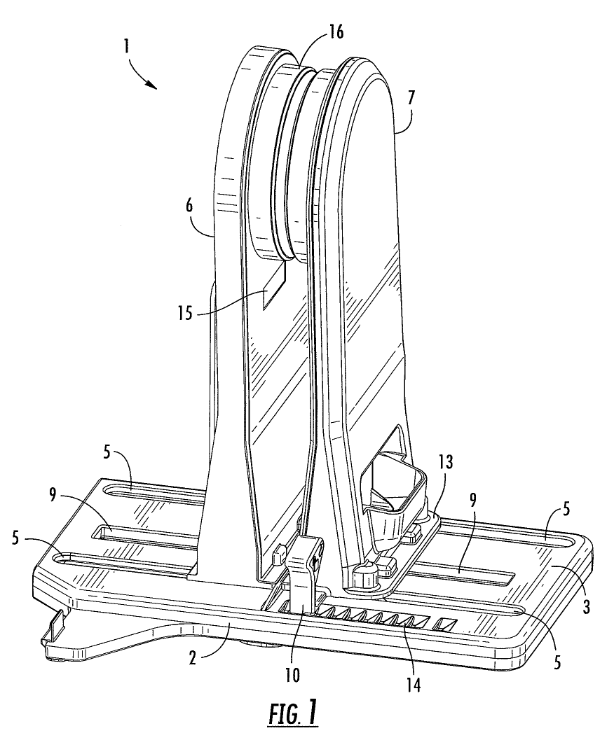

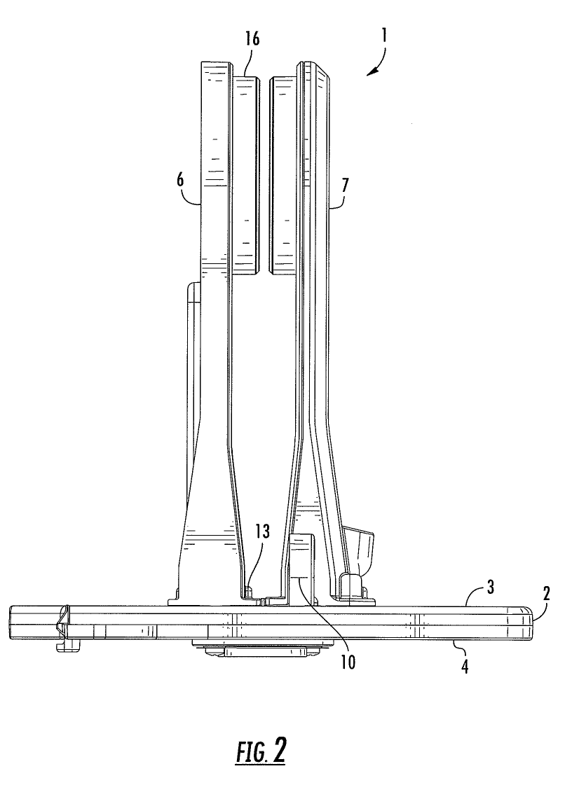

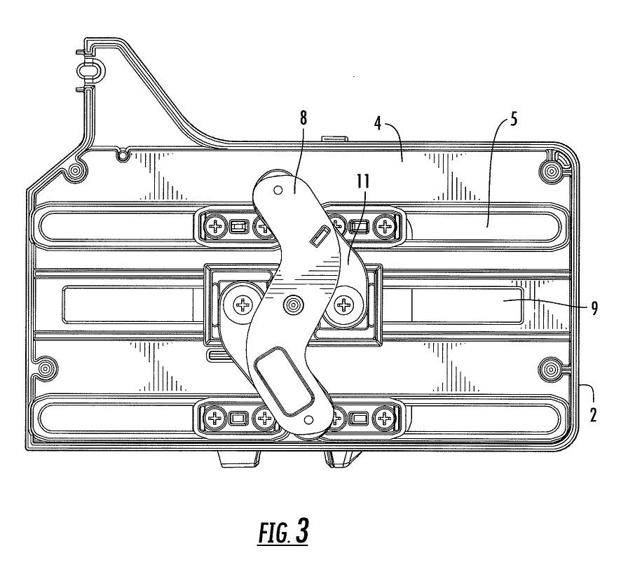

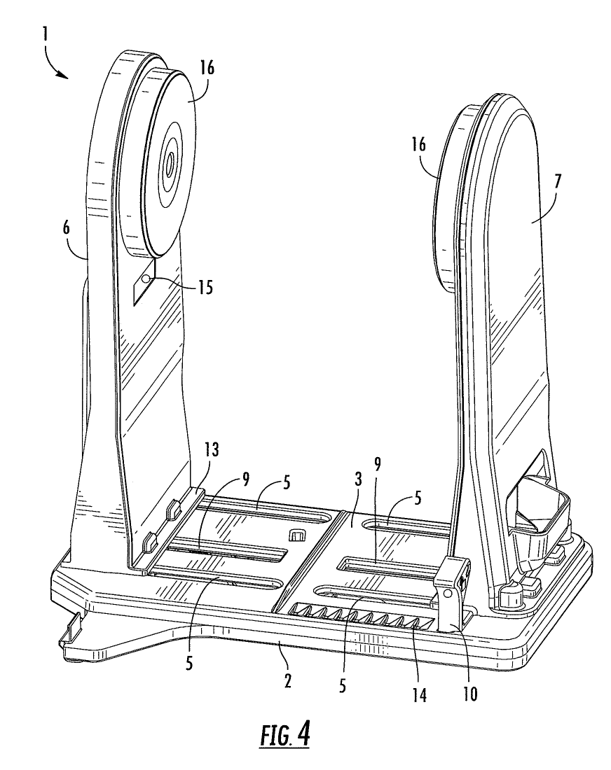

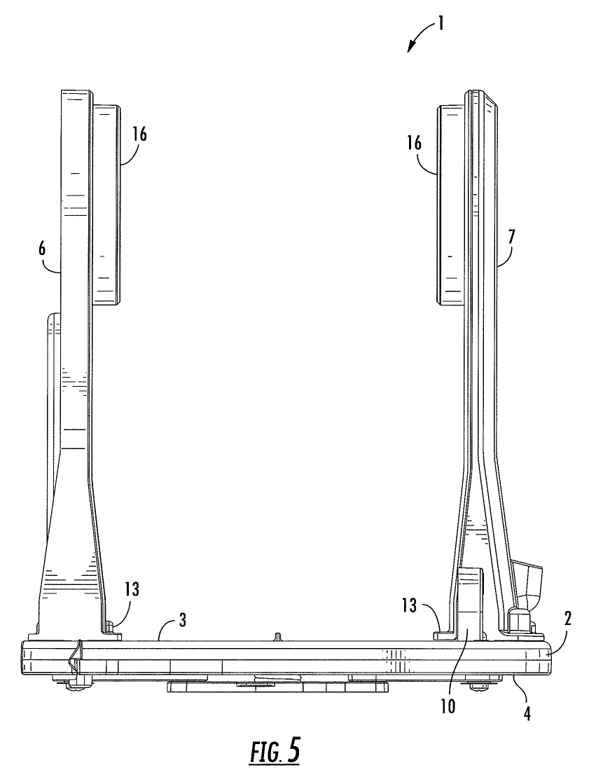

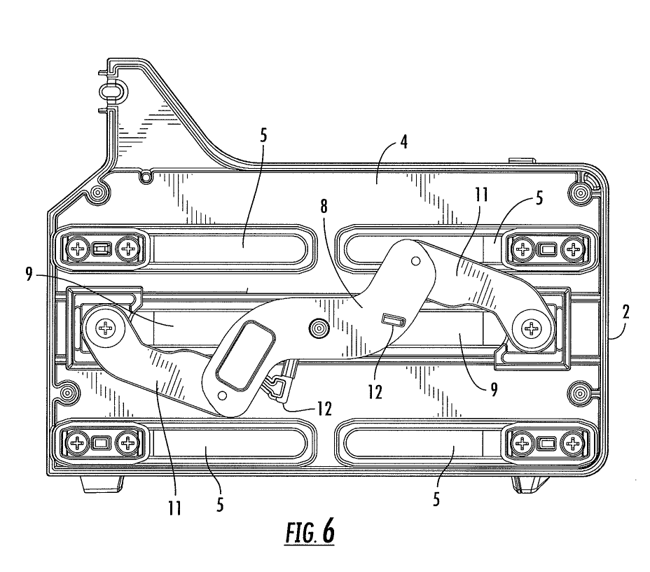

Referring now to the drawings, FIGS. 1-3 illustrate various views of the present invention in an compressed or closed position and FIGS. 4-6 illustrate various views of the present invention in an expanded or open position, wherein a media may be inserted therein. As shown and illustrated in an exemplary embodiment, a media hanger/guide 1 is provided and includes a base plate 2 configured for mounting the hanger 1 within a printing system (not shown) and having a first surface 3 and a second surface 4 opposed to the first surface 3. In exemplary embodiments, the base plate 2 is provided with at least one securing screw for mounting the base plate to the printing system. At least one guide track or guide 5 is provided and extends through the base plate 2. A first support member 6 and a second support member 7 are provided and adapted for being partially disposed within the guides 5 and having a sliding movement along connection points which mate with the guides 5. The support members 6 and 7 are configured to slide relative to the base plate second surface 4 between a first open or expanded position and a second closed or compressed position. It will be appreciated by those skilled in the art that while the drawings depict four guides 5 for permitting movement of the support members 6, and 7 any number of guides may be used, including just one.

In exemplary embodiments, a clamp 8 is provided and rotatably secured to the base plate second surface 4 and engaged with the support members 6 and 7. In operation, the clamp 8 may be rotated in a clockwise direction thereby causing the support members 6 and 7 to move along the guide 5 relative to the base plate 2 to a first or open position adapted for permitting insertion of a media (not shown) between the first support member 6 and the second support member 7. Alternatively, the clamp 8 may be rotated in a counter-clockwise direction thereby causing the support members 6 and 7 to move along the guide 5 relative to the base plate 2 to a second or closed position adapted for providing force on the first support member 6 and the second support member 7. In exemplary embodiments, a slot 9 may also be provided which extends into or through the base plate 2. In still other exemplary embodiments, a locking mechanism or lock 10 may be provided and movably secured to the base plate 2 for locking the first and second support members 6 and 7 in a predetermined position along the base plate 2.

In exemplary embodiments, the clamp 8 may include a pair of linking arms 11 extending therefrom. The point wherein the clamp 8 is rotatably secured to the base plate second surface 4 may be referred to as the pivot point. The linking arms 11 are secured to the support members 6 and 7, with such connection preferably located at the distal ends of the linking arms 11, although connections along other locations along the linking arms 11 is also contemplated. A biasing mechanism 12 is secured to the clamp 8 such that upon rotation of the clamp 8 at its pivot point to the second position, a compressive force is exerted so as to move the support members 6 and 7 in a synchronized manner toward one another along the guide 5. The biasing mechanism 12 may be any type of biasing mechanism including, but not limited to, a torsion spring.

In exemplary embodiments, the support members 6 and 7 may include mounting plates 13 located on the bottommost portion of the support members 6 and 7. The mounting plates 13 are preferably sized and shaped so as to permit the support members 6 and 7 to movably slide along the guides 5 when the clamp 8 is manipulated. The link arms 11 are most preferably secured to the mounting plates 13 of the support members 6 and 7.

The lock 10 is utilized to hold the media hanger/guide 1 in a compressed position as shown in FIGS. 4-6. Threads 14 may be located on the base plate top surface 4. The threads 14 are sized and shaped so as to accommodate the lock 10 in a fixed position, thereby maintaining the support members 6 and 7 in the second position. Because a plurality of threads 14 are located on the first surface 3, the lock 10, and thus support members 6 and 7, may be manipulated such that the support members 6 and 7 may lock and remain in various positions along the guide 5 and relative to the base plate 2. Maintaining the support members 6 and 7 in various positions along the guide 5 is especially desired when using fan-fold media.

A sensor 15 may also be provided and located on a support member 6 or 7. The sensor 15 is adapted to detect the presence and/or absence of media in the media hanger/guide and is in communication with control circuitry (not shown). The sensor 15 may be an optical sensor, a mechanical sensor, or another suitable sensor as known in the art. The presence or absence of media, as determined by the sensor 15, influences functions of a printer (not shown) according to programming within the control circuitry to which the sensor 15 is connected. The sensor 15 may be used with roll media, although use of the sensor in conjunction with media of other types is also contemplated.

Additionally, the present invention may include pair of hubs 16 of varying sizes, including, but not limited to, 3″, 1.5″, 1″, or a combination thereof. The pair of hubs 16 may be removably fixed or interchangeable with the support members 6 and 7 at an interior surface of their respective ends, and are used for holding media of various sizes.

With specific reference to FIGS. 4-6, various views of the present invention in a open position are shown. As shown, the support member 6 and 7 are in a fixed position along the guide 5 relative to the base plate 2 such that media may be inserted between the support members 6 and 7.

To use the media hanger/guide 1 of the present invention, a media is inserted within the media hanger/guide 1 when the distance between the support members 6 and 7 permit accommodation of the media. Such first position permits loading of rolled media, use of the media hanger/guide 2 for fan-fold media, or any other use of the media hanger/guide 2. The clamp 8 is then manipulated so as to move the support members 6 and 7 toward one another along the guide 5 to a desired distance between the support members 6 and 7. Such manipulation of the claim 8 results in simultaneous and synchronized movement of the support members 6 and 7. Because such simultaneous and synchronized movement occurs, the media is centered within the media guide/hanger 1. Compressive forces applied on the media is constant, as opposed to linear, and such forces are not dependent upon the media width. The compressive forces are dependent upon a combination of factors, including, but not limited to, initial load on the biasing mechanism 12, the stiffness of the biasing mechanism 12, the pivot point geometry of the clamp 8, and the length of the link arms 11. The compressive force is a constant force and decreases vibration of the media, which in turns decreases the likelihood of the media rolling off of the media hanger/guide 2 and decreases the likelihood of blurred or offset printing.

Although not shown, the present invention may be used to guide and house media of various forms, including, but not limited to, rolled media and fan-fold media.

The embodiments described above provide advantages over conventional media hanger/guide devices and associated methods of manufacture. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Furthermore, the foregoing description of the preferred embodiments of the invention and best mode for practicing the invention are provided for the purpose of illustration only and not for the purpose of limitation—the invention being defined by the claims.

What is claimed is:

1. A media hanger, comprising:
a base plate having a first surface and a second surface opposed to the first surface and at least one guide extending into the second surface;
first and second support members disposed within the at least one guide and being adapted for sliding movement along the at least one guide relative to the base plate second surface; and
a clamp secured to the base plate second surface and engaged with the support members, the clamp movable between a first position adapted for permitting insertion of a media between said first and second support members and a second position adapted for providing force on the first and second support members.

2. The media hanger of claim 1, further comprising a locking mechanism movably secured to the base plate for locking the first and second support members in a predetermined position along the base plate.

3. The media hanger of claim 1, further comprising a sensor located on the first support member.

4. The media hanger of claim 1, wherein the at least one guide comprises four guides.

5. The media hanger of claim 1, wherein the clamp comprises a pair of linking arms connected to and extending from the location where the clamp is rotatably secured to the base plate, said linking arms being connected to the first and second support members such that as the linking arms are manipulated between a first position and a second position the support members move in a corresponding, synchronized manner.

6. The media hanger of claim 5, wherein the clamp further comprises a biasing mechanism that is secured to the clamp such that upon rotation of the clamp at a pivot point to a second position, a compressive force is exerted so as to move the support members toward one another along the at least one guide.

7. The media hanger of claim 6, wherein the biasing mechanism is a torsion spring.

8. The media hanger of claim 3, wherein the sensor is in communication with control circuitry of a printing device.

9. The media hanger of claim 8, wherein the sensor is selected from the group consisting of an optical sensor or a mechanical sensor.

10. The media hanger of claim 1, further comprising hubs removably secured to the first and second support members for holding media of various sizes.

11. A media hanger operable for maintaining varying types of media within a printing system, comprising:
a base plate configured for mounting within a printing station, said base plate having at least one guide track extending there through;
first and second support members movably connected to the at least one guide track and being adapted for sliding movement relative to the base plate; and
a clamp secured to the base plate and engaged with the support members, the clamp being configured for movement between a first position adapted for permitting insertion of a media between said first and second support members and a second position adapted for providing force on the first and second support members.

12. The media hanger of claim 11, further comprising a lock movably secured to the base plate for locking the first and second support members in a predetermined position along the base plate.

13. The media hanger of claim 11, further comprising a sensor located on the first support member.

14. The media hanger of claim 11, wherein the at least one guide track comprises four guides.

15. The media hanger of claim 11, wherein the clamp comprises a pair of link arms connected to and extending from the location where the clamp is rotatably secured to the base plate, said link arms being connected to the first and second support members such that as the link arms are manipulated between a first position and a second position, the support members move in a corresponding manner.

16. The media hanger of claim 15, wherein the clamp further comprises a biasing mechanism that is secured to the clamp such that upon rotation of the clamp at a pivot point to a second position, a compressive force is exerted so as to move the support members toward one another in a synchronized manner along the at least one guide track.

17. The media hanger of claim 13, wherein the sensor is an optical sensor.

18. The media hanger of claim 11, further comprising a pair of hubs removably secured to the support members for holding media of various sizes.

19. The media hanger of claim 18, wherein the a pair of hubs have a diameter of the group consisting of 3 inches, 1.5 inches, or 1 inch.

20. A media hanger for use with a printing system, comprising:
a base plate configured for mounting within a printing station, said base plate having at least one guide track extending there through;
first and second support members movably connected to the at least one guide track and being adapted for sliding movement relative to the base plate;
a clamp secured to the base plate and engaged with the support members, the clamp being configured for movement between a first position adapted for permitting insertion of a media between said first and second support members and a second position adapted for providing force on the first and second support members;
a lock movably secured to the base plate for locking the first and second support members in a predetermined position along the base plate; and
wherein the clamp comprises a pair of linking arms connected to and extending from the location where the clamp is rotatably secured to the base plate, said linking arms being connected to the first and second support members such that as the linking arms may be manipulated between a first position and a second position thereby causing the support members move in a corresponding manner.
